(19) United States
(12) Patent Application Publication
(10) Pub. No.: US 2026/0240219 A1
(43) Pub. Date: Aug. 20, 2026

(54) Harvester

(71) Applicant: MARJO ENGINEERING, LLC, Marriottsville, MD (US)

(72) Inventor: John T. Sullivan, Marriottsville, MD (US)

(21) Appl. No.: 19/546,729

(22) Filed: Feb. 23, 2026

Related U.S. Application Data
(63) Continuation-in-part of application No. 18/155,796, filed on Jan. 18, 2023, now Pat. No. 12,582,043.
(60) Provisional application No. 63/361,730, filed on Jan. 18, 2022.

(51) Int. Cl. A23N 15/02

(52) U.S. Cl. CPC A23N 15/02

(57) ABSTRACT

A harvester for removing cannabis flower from stalks includes a blade follower iris that adjusts the size of the flower-stripping opening to correspond to the diameter of the stalk. The size of the opening may be controlled by centrifugal and/or spring forces that cause the iris to open and close. The stalks may be pulled past the cutting blades by stalk-gripping mechanisms including at least one of a pair of fixed and floating drive belts, a pair of fixed and floating pinch rollers having complementary V-shaped circumferential surfaces, or a gripping mechanism including a pair of jaws that is movable along a linear track and reciprocally driven by a linear actuator or crank mechanism In addition, the harvester may include wipers for the belts or pinch rollers of the stalk pulling mechanism, and sensors for detecting the presence or movement of a stalk in the cutting assembly and the pulling mechanism.

### CROSS-REFERENCE TO RELATED APPLICATIONS

This application is a continuation-in-part of U.S. patent application Ser. No. 18/155,796, filed Jan. 18, 2023, which claims the benefit of U.S. Provisional Patent Appl. Ser. Nos. 63/361,730, filed Jan. 18, 2022, each of which is incorporated by reference herein.

### BACKGROUND OF THE INVENTION

### 1. Field of the Invention

This invention relates to an apparatus for removing cannabis flowers, hemp flowers, rose flowers, sunflowers, and any flowers with seeds from the stem, stalk, or branches (hereinafter referred to as the “stalk” of a cannabis plant). The apparatus of the invention eliminates the disadvantages of a conventional bucking machine, including the need for an operator to match the stalk to select an appropriately sized hole in the bucking machine. The bucking machines bunch the flowers, compressing them against the oversized holes, preventing the cut flowers from dropping. Unlike conventional bucking machines, the bucking machine of the invention preferably has the ability to cycle the stem forward and reverse to release the cut flower, using the blades to open and close in reverse to prevent bunching.

The invention also relates to cutting blade mechanisms for engaging stalks of varying diameter to strip the stalks as they are pulled past the blades, mechanisms for automatically drawing stalks into a bucking machine and past flower-stripping blades while preventing build-up of sticky residues, and methods for preventing or overcoming jamming caused by the residues.

The stalk pulling mechanisms may include devices that pinch the stalks between moving belts or rollers, as well as devices that grab and pull stalks past the cutting blades along linear tracks in both forward and that automatically reverse directions to clear debris and prevent jams.

### 2. Description of Related Art

The process of removing cannabis flowers from the stalk is very labor-intensive. The flower removal process requires the operator to cut the flowers from the stem, stalk, or branch using hand labor scissors or something called a bucking machine.

The conventional bucking machine consists of a metal, wood, or plastic plate with several different holes in the plate. The operator must look at the stalk in their hand and try to match the diameter of the stalk to the hole size that is the closest match to the stalk diameter. The stalk is then pulled through the hole by two rubber drive wheels that frictionally engage the stalk, causing the flower to be stripped from the stalk as it pulled through the selected hole.

The need for hole size matching has the disadvantage that it is time-consuming and requires a great deal of skill and concentration on the part of the operator. If the hole is too small, the stalk will not fit in the hole and the flower cannot be removed, but If the operator places a small stalk in a large hole, the flower will be pulled through the hole with the stalk and be destroyed.

In addition, conventional bucking machines have the disadvantage that the use of two rubber drive wheels to pull the stalk through the fixed diameter holes destroys the natural shape of the flower, reducing the go-to-market value of the flower. Moreover, the biomass removed by pulling the stalk through the hole leaves a sticky residue on the rollers that is difficult to remove, exacerbating the problem that the pinch point where conventional disc-shaped rollers deform under compression exerts a drag on rotation that requires a lot of energy to overcome. If the stalk is too large in diameter, the gear that rotates the drive wheels will stall, so that the operator must put the motor in reverse to unclog the stalk jammed between the rollers, causing delays in the flower removal process.

The present invention addresses heretofore unsolved problems of compressing, snatching, ripping, and tearing the flower from the stalk with an improperly sized hole, damage to the shape of the flower even when the hole is properly sized, removal of sticky residue, and clogging of the machine due to jamming of stalks as they are pulled past cutting blades during flower removal.

### SUMMARY OF THE INVENTION

It is accordingly a first objective of the invention to provide an apparatus that overcomes the disadvantages of conventional cannabis-flower-removing bucking machines or harvesters without the need for additional labor, by providing a bucking machine in which the stalk stripping opening by an iris blade follower mechanism that automatically matches hole size to stalk diameter, so that the stalk is pulled through the machine and the flower removed without destroying or affecting the natural shape of the flower.

Additional objectives of the invention include (i) provision of a cannabis flower removing apparatus that is convenient to operate and maintain, (ii) reduction in clogging and build-up of sticky residue on the stalk pulling mechanism to avoid the need for frequent reversals of the stalk pulling mechanism and delays in the flower removal process, (iii) provision for easy tool-free disassembly for cleaning, and/or (iv) enabling adjustments to compensate for wear and tear.

These and other objectives of the invention are achieved, according to the first exemplary embodiment disclosed in parent application Ser. No. 18/155,796, filed Jan. 18, 2023, by providing a harvester in which the stalk-stripping mechanism includes an iris consisting of centrifugal spring-loaded cutting blades that form an opening whose size increases in response to a spring force when the cutting blade assembly is rotated at a slow speed or when the rotation is stopped, and whose size decreases at high rotation speeds as centrifugal forces overcome the spring force. The centrifugal force that opens and closes the blades can be adjusted by adjusting the rotation speeds and depends on fixed or adjustable weights included in the cutting blade assembly. The size of the opening depends on the relative position of cutting or stripping edges of the two cutting blades, which in the exemplary embodiment of the invention are the edges of overlapping holes in the two plates, the degree of overlap changing with the centrifugal force on the plates to vary the size of the hole.

In the first exemplary embodiment, each plate has a hole and the opening changes from round to oval as the plates are moved to a closed position in response to increasing rotation speed, although it will be appreciated that an iris effect can also be achieved with an arrangement in which one of the plates has a hole and the other plate has a corresponding curved edge that overlaps the hole. The hole(s) may optionally be serrated or undercut to increase a sharpness of the edges.

The plates of the first exemplary embodiment may be coupled to a rotating, motor-driven hub by bearings that allow relative pivoting of the plates during rotation in response to the centrifugal forces caused the by rotation, which movement stops limiting the pivoting movement at high rotation speeds. The movement stops may be defined by guide slots in the plates and corresponding posts in the rotating hub.

As the centrifugal forces resulting from rotation of the cutting mechanism overcome the spring tension, the pair of pivotal plates move outward in opposite directions to cause edges of the opening to move inwardly and form an ellipse of increasing eccentricity that pinches the stalk surface 180 degrees apart. The use of bearing followers to achieve the rotation and pivoting prevents the countersink rotation plate or cutting blades from cutting into the stalk, while achieving a chisel effect at the flower's apex where it is joined to the branch. As a result, the countersink rotating plate or cutting blades will only cut flowers and branches projecting outward from the surface of the stalk, in a manner similar to a razor blade trimming facial hair without cutting the skin. Pivoting of the countersink rotating plate or movement of the spring-loaded cutting blade holder in a reverse direction under either compression or extension spring forces returns the iris stem follower aperture formed by the overlapping holes to an open position when the rotational speed of the motor is lowered

Because the countersink rotating plate or opposing branch followers are provided on a bearing follower to float as they pinch 180 degrees of the stalk in rotation, the ellipse shaped pinch hole is allowed to constantly adjust with the continually changing shape and thickness of the branch as it is being pulled through the cutter assembly. The amount of pinch friction applied to the stalk can be adjusted by adjusting motor rotation speeds, the weight of plate or blade mounting weight, or compression or extension spring loading.

In addition to the above-described cutting mechanisms, the first exemplary embodiment of the invention provides for a timing belt or conveyor belt drive system that is used to pull the stalk through the stalk stripping opening and into the harvester. The drive system employs two or more adjustable turnbuckles to adjust the tension of individual drive belts and a third adjustable turnbuckle that applies a spring-loaded force tension between timing or conveyor belts and a drive pull belt. A floating bearing assembly moves up and down in linear slots of the belts while applying spring-loaded forces between the two belts with one of the belts being fixed in a position. The other drive belt floats between the two drive pull belts to pull a branch, or both belts float in a linear bearing track with spring tension on both sides to pinch a stalk and drag the biomass into the cutter assembly.

The stalk pulling conveyor belts have a bearing system with a male and female cavity to allow the top or bottom belt to move while one belt is fixed. A wiper is placed between the two belts to prevent debris from getting caught between the sidetracks of the belts to prevent a clog. The wiper can be a mating male and female cavity or a fixed strip of a plastic or metal strip. A toggle spring loaded tension on either side of the two belts to creates a force on the stalk being pulled by the two drive belts that are controlled by a speed controller. The cutting assembly is mounted on a door with a hinge that allows access to the belts that operate inside of the rotating cutting assembly.

The speed of the rotating blades of the first exemplary embodiment can be controlled with an electrical input to control predetermined or variable speed controls by adjusting the belt or roller pull speeds relative to the rotating speeds of the cutter to optimized the cut of the flower without snatching the flower from the stem. The electrical input to control cutting blade rotation can be provided by a foot switch, optical sensor or mechanical sensor that communicates with the motor controller. The motor the drives the cutter can be a belt driven motor or hub-less motor with a hollow shaft. The conveyor pull belts are extended through the bearing assembly or hub-less motor to minimize the length of the stem needed to engage with the stem to pull it through the cutters. In addition, the rotation of the cutting plates or blades can be controlled by a loadcell on the bearing assembly, or an on/off timer that spins the cutting blades at a predetermined amount of time after the presence of a stalk is sensed, before the blades open again by stopping rotation or slowing the cutting mechanism rotation speed.

In order to compensate for stretching and position changes in the drive belt over time due to wear and abuse, the cutter rotating assembly may be mounted on a leadscrew stage to adjust the gap between the input of the cutter housing and the drive belts as they stretch and change position.

In order to facilitate cleaning and unclogging of the cutter assembly, the drive system of the exemplary embodiment may be taken apart without tools. The drive system is assembled using three adjustable toggle clamps, two of which take the slack adjustment out of the top and bottom motor driven belt pulleys. A third toggle clamp is used to apply a spring-loaded compression force between a fixed bottom belt drive assembly and the floating top belt drive assembly. The top belt floats on four roller bearings in a mating slot allowing the top spring-loaded to move up and down to accommodate the different stalk sizes. Each belt is driven by two different motors or a chain of pulley systems that uses one motor. One electrical resistive trip pot may be provided to synchronously control the exact motor speed of both motors. When all three toggle clamps are released, the two drive pull belts are easily removed for cleaning or replacement.

Cleaning and service may be further facilitated by arranging the system's front door on hinges to open the cabinet. Safety interlocks turn the motors off when any of the doors are opened.

As an alternative to the first exemplary embodiment of the invention, parent application Ser. No. 18/155,796 also discloses a centrifugal force-actuated cutting blade variation in which the pivoting cutting blades of plates of the first exemplary embodiment may be replaced by a predetermined stacked weighted cutter having spring loaded return arms with wheels to reduce friction. In this second exemplary embodiment, the stacked weights produce enough centrifugal forces to compress a return spring (not shown) when the cutting housing not shown is spinning.

The present application discloses various modifications to the cutting blade and stalk pulling mechanisms of the exemplary embodiments disclosed in parent U.S. patent application Ser. No. 18/155,796. It will be appreciated that these additional embodiments including cutting blade and stalk-pulling mechanisms that can be used in various combinations with each other and/or with the cutting blade and stalk-pulling mechanisms of the first exemplary embodiment. For example, the linearly-actuated cutting blade mechanism described herein may be used with any of the stalk-pulling mechanisms of the exemplary embodiments, while the various stalk pulling mechanisms may alternatively be combined with the centrifugal cutting blade mechanism of the first exemplary embodiment. In addition, features of the first exemplary embodiment, such as details of the housing and/or controller, may be shared by or utilized in any of the additional exemplary embodiments disclosed herein or, conversely, details of the additional exemplary embodiments disclosed herein may be utilized in other of the additional embodiments or in the first exemplary embodiment.

As noted above, one of the problems with handling cannabis, hemp, and other plant-based products is the stickiness and string-like behavior when compressed between two radii. This is a disadvantage of mechanisms that use conventional disc-shaped rollers with flat circumferences. The stem of the plant-based product wants to take the shape of the roller radius, causing a clog as the stem or branch wraps around the rollers instead of exiting directly out of the back of the harvester.

This problem is addressed, in a third exemplary embodiment of the invention, by replacing the dual conveyor belts of the stem pulling mechanism of the first and second exemplary embodiments with a bottom roller having a V-shaped circumferential groove and a floating top roller having a V-shaped periphery that extends into the V-shaped circumferential groove to capture and frictionally engage the stem so that the stem can be moved in forward and reverse directions as the respective rollers are synchronously rotated in corresponding forward and reverse directions by a pair of motors. A fixed bottom wiper engages the V-shaped groove of the bottom roller to wipe the branch or stem off the roller during rotation, while a top wiper moves with the floating top roller to maintain engagement with and scrape the apex of the V-shaped periphery of the top roller, thereby preventing a clog from the branch or stem that could follow the rollers. Bearings for the floating top roller, and the top wiper, are slidably mounted on a pair of linear tracks to enable the top wiper to follow the travel of the top roller as it moves linearly to accommodate different stem thicknesses, so that the wiping is consistent with the travel of the moving roller as it slides on linear tracks. The bottom wiper is fixed with respect to the bottom pinch roller assembly. The bottom wiper is attached to an access door so that the wiper can be removed for cleaning and inspection from both sides of the harvester.

In a fourth exemplary embodiment, the cutting mechanism of the first preferred embodiment may be replaced by linearly movable cutting blades with respective circular apertures whose intersection defines the cutting opening through which the stalk is passed to remove flower from the stalk. The blades are moved apart by respective solenoids to align the apertures and therefore create a circular opening though which the stalk may be freely inserted, and are moved in an opposite direction by a spring so as to cause the sides of the opening to move towards each other and engage the stalk when the solenoids are deenergized. The force exerted on the stalk by the inwardly moving cutting edges of the elliptical opening defined by the intersection of the apertures may be adjusted by increasing or decreasing the spring tension by a rotatable connector fixed to one end of the spring. Alternatively, opening and closing of the blades can be achieved by replacing the solenoids with a stepper motor, servo motor, or other linear actuator.

In a fifth exemplary embodiment, the belts or drive rollers of the first and second embodiments are may be replaced by a linearly movable gripper device having jaws that open and close to grip and release a stalk, and that is moved along a linear track by an air cylinder, servo motor, stepper motor, or brushless DC motor. The jaws may be actuated by, for example, a solenoid.

Finally, in a sixth exemplary embodiment, the linear actuator that moves the gripping mechanism along the track may be replaced by a reciprocating, motor driven crank mechanism whose range of motion is determined by adjusting a position of a crank arm relative to a rotating crank wheel.

### BRIEF DESCRIPTION OF THE DRAWINGS

FIG. 1 is an isometric front view of cutting blade assembly according to a first exemplary embodiment of the invention.

FIG. 2 is an isometric rear view of the cutting blade assembly of FIG. 1 as a stalk is being pulled through the cutting assembly.

FIG. 3 Is n isometric front view of the cutting blade assembly of FIGS. 1 and 2 as the stalk is pulled through the cutting assembly.

FIG. 4 Is a cut-way side view of flowers and stem 40 being inserted the cutting assembly of FIGS. 1-3.

FIG. 5 Is an isometric front view of a cutter and bearing housing that contains the cutting assembly of the first exemplary embodiment.

FIG. 6 is an isometric front view of the housing of FIG. 5 shown with the stationary guard and funnel illustrated in FIG. 5 removed.

FIG. 7 is a second cut-way side view of the cutting blade assembly of the first exemplary embodiment.

FIG. 8 Is a cut away top view of a cutter assembly and drive belt system according to the first exemplary embodiment.

FIG. 9 is a front view showing a funnel and closing top and blades 1,2 according to the first exemplary embodiment.

FIG. 10 is a front view corresponding to the front view of FIG. 9 in which the blades 1,2 have been moved to an open position.

FIG. 11 is an isometric view of a rotating cutting flower harvester that includes the cutting assembly and housing of the first exemplary embodiment of the invention.

FIG. 12 is an isometric view of the flower cutter of FIG. 12 with the door 87 open.

FIG. 13 is a cut away top view of an adjustable drive belt assembly with belt discharge wipers according to the first exemplary embodiment of the invention.

FIG. 14 is a top view of a stem 113 and cut flower 114 being moved by the drive belt assembly of FIG. 13.

FIG. 15 is a cut away top view of the rotating cutting flower harvester of the exemplary embodiment.

FIG. 16 is an isometric view of the rotating flower cutter and motors without the stationary guard and funnel of the first exemplary embodiment.

FIG. 17 is an isometric rear view of the flower harvester of the first exemplary embodiment.

FIG. 18 is another isometric side view of the flower harvester of the first exemplary embodiment.

FIG. 19 is an isometric front view of top and bottom stalk pulling assemblies according to the first exemplary embodiment.

FIG. 20 is an isometric front view further illustrating the stalk pulling assemblies of FIG. 19.

FIG. 21 is an isometric side view of the stalk pulling assemblies of FIGS. 19 and 20.

FIG. 22 is an isometric side view of an opposite side of the stalk pulling assemblies shown in FIG. 21.

FIG. 23 is a front view of the stalk pulling assemblies of FIGS. 19-22 after removal for cleaning.

FIG. 24 is an isometric view of the removed stalk pulling assemblies of FIG. 23.

FIG. 25 is an isometric view of cutting assembly according to a second exemplary embodiment of the invention.

FIG. 26 is a front view of a harvester that includes the cutting assembly of FIG. 25.

FIG. 27 is a perspective view of a branch or stem pulling assembly with two pinch roller assemblies, one of which is fixed and the other floating, according to the third exemplary embodiment of the invention.

FIG. 28 is a rear perspective view of the branch or step pulling assembly of FIG. 27.

FIG. 29 is a rear perspective view of the branch or step pulling assembly of FIG. 28 after removal of the housing.

FIG. 30 is a perspective view of the flower harvester of the third exemplary embodiment with a removable plate held in place by toggle clamps.

FIG. 31 is a cut-away perspective view of the rear exit pulling assembly for the third exemplary embodiment.

FIG. 32 is an enlarged perspective view of flower harvester of the third exemplary embodiment.

FIG. 33 is a cut-away perspective view of the flower harvester of the third exemplary embodiment.

FIG. 34 is a cut-away view of the flower harvester of the third exemplary embodiment, showing the entire housing.

FIGS. 35 and 36 illustrate the operation of the drive assembly and pincher blades of the third exemplary embodiment, including alternating backwards and forwards movements to prevent clogs.

FIG. 37 is an enlarged perspective view of the drive assembly of the third exemplary embodiment, showing details of the upper and lower wipers.

FIG. 38 is a perspective view of the drive assembly of FIG. 37, showing the side plates and sensors that detect a stem or stalk as it is pulled by the pinch roller.

FIG. 39 is a perspective view of the back of the harvester of the third exemplary embodiment.

FIG. 40 is an enlarged perspective view corresponding to FIG. 39, but with the door removed.

FIG. 41 is a perspective view of rear side of the door of FIG. 40.

FIG. 42 Is another perspective view of a pinch roller assembly of the third exemplary embodiment.

FIGS. 43 and 44 are perspective views of a cutting blade assembly for the harvester of the third exemplary embodiment in respectively, an open position and a closed position.

FIG. 45 is a rear view of the harvester of the third exemplary embodiment, showing the cutting blade assembly in a fully open position.

FIG. 46 is a partially transparent rear view of the harvester of the third exemplary embodiment, showing the cutting blade assembly in a closed position.

FIG. 47 is a front view of the cutting blade assembly of FIGS. 43-46.

FIG. 48 is a partially transparent front view of the cutting blade assembly of FIGS. 43-46, showing a roller bearing assembly for enabling friction-free movement of the cutting blades.

FIG. 49 is a top view of the cutting blade assembly shown in FIGS. 43-48.

FIG. 50 is a perspective view of an alignment bushing for use in the cutting blade assembly in FIGS. 43-49.

FIGS. 50 and 51 are perspective views of a cutting blade assembly according to a fifth exemplary embodiment of the invention, in which stalk is held and pulled linearly along a track.

FIGS. 52 and 53 are front and rear perspective views of a variation of the exemplary embodiment of FIGS. 50 and 51, in which oscillating linear movement of a stalk-pulling device is provided by a crank mechanism.

### DETAILED DESCRIPTION OF PREFERRED EMBODIMENTS

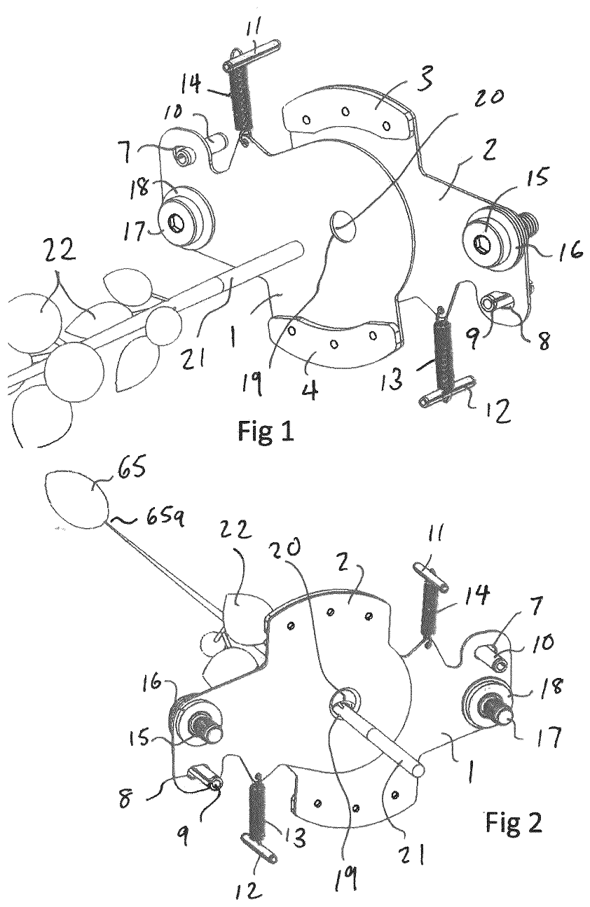

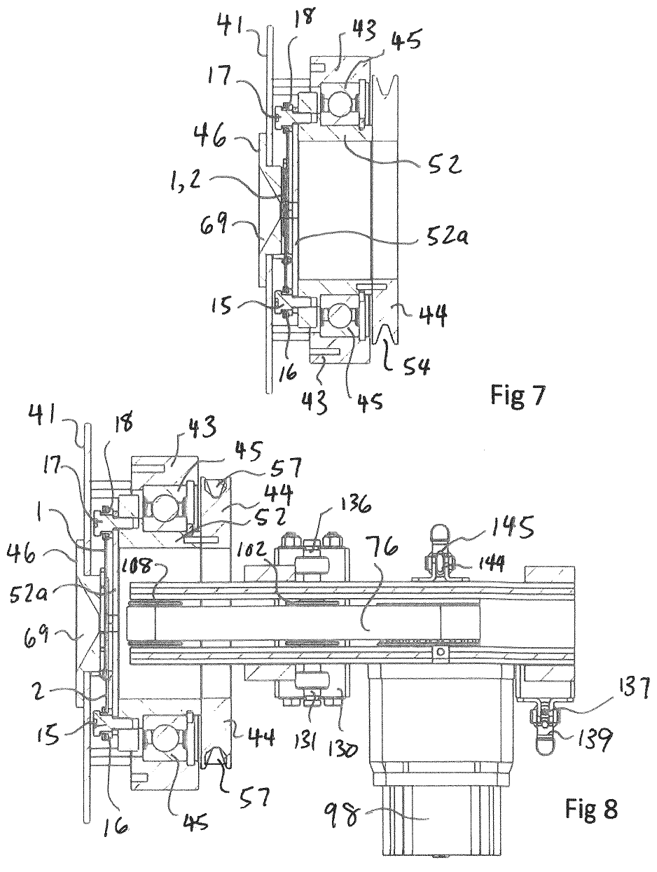

FIGS. 1-7 show the cutting assembly of a harvester for removing cannabis flowers and leaves from a stalk, stem, or branch in accordance with the principles of a first exemplary embodiment of the invention. The cutting assembly includes two centrifugal cutting plates or blades 1,2, each including a respective weight 3,4 and circular cutting hole 19,20. As shown in FIG. 1, the cutting holes are aligned to form a circular opening for receiving a stalk 21, while FIG. 2 shows that the cutting blades 1,2 have moved apart as a result of centrifugal force, applied in the manner described below, so that the circular holes 19,20 in the respective cutting blades 1,2 are offset and their intersection forms a reduced-size elliptical opening or aperture whose minor axis corresponds to a diameter of the stalk 21.

Each cutting blade 1,2 includes bearings 16,18 for receiving bearing posts 15,17 fixed to a rotatable hub 52 such that rotational motion of the hub is transmitted to through the bearing posts 15,17 to the cutting blades 1,2 to enable the entire cutting assembly to rotate about a central axis of the cutting assembly. As illustrated in FIG. 4, the rotating hub 52 is fixed to and rotated by a pulley 44 having a belt groove 54. The centrifugal rotating cutting blades 1,2 are spring loaded by springs 13,14 attached at one end to the respective cutting blades 1,2 and at the other end to posts 11,12 that are fixed to the rotating hub assembly. Cutting blades 1,2 further include slots 7,8 through which posts 5,6 connected to the hub 52 extend to respectively guide pivoting of the cutting blades 1,2 relative to the hub in directions 5,6 as the entire cutting assembly is rotated. As explained below, pivoting of the cutting blades 1,2 relative to the rotating hub is the result of a spring force that causes the cutting blades 1,2 to pivot about the bearing posts 15,17 in a direction that increases the size of the stalk stripping opening or iris formed by the intersection of cutting holes 19,20, and a centrifugal force the causes the cutting blades 1,2 to move in a direction that decreases the size of the stalk stripping opening.

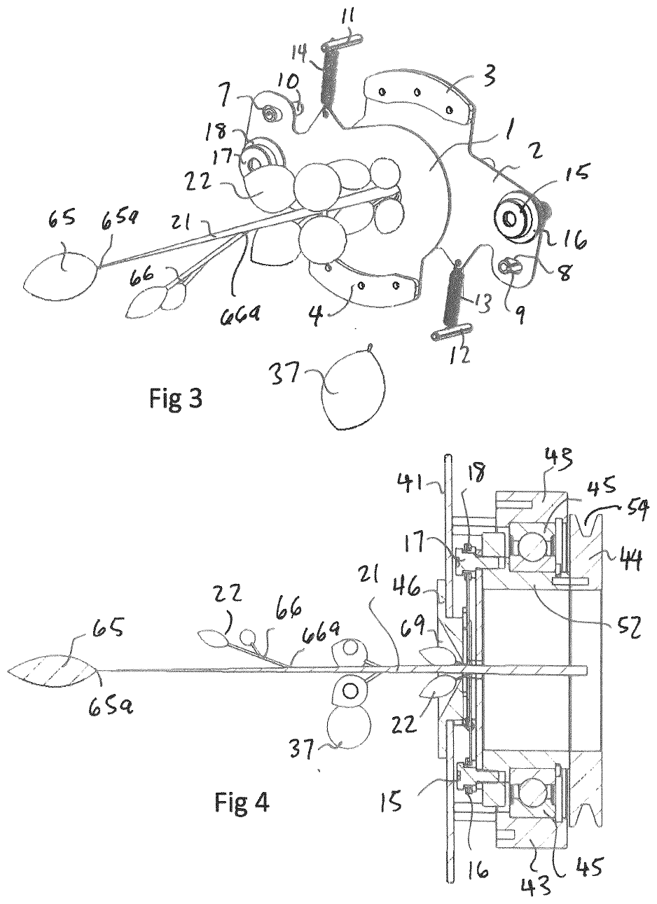

As illustrated in FIGS. 1-3, the stem 21 of flowers (and/or leaves) 22 being cut is inserted into an opening that is formed by overlapping holes 19,20 when cutting blade 1 is pivoted in a counterclockwise direction, as viewed in FIG. 1 from the front of the cutting assembly, and cutting blade 2 is pivoted in a clockwise direction as viewed in FIG. 1. It will be appreciated that a corresponding iris effect could also be achieved by just pivoting one of the cutting blades 1,2, while the other of the cutting blades 1,2 is fixed relative to the rotating hub. Pivoting to the open position results from the action of springs 13,14, which overcome the reduced or zero centrifugal force at lower rotating speeds or when the motor that applies the centrifugal force is stopped. When the rotating speeds are increased, the centrifugal forces on weights 3,4 overcome the spring tension provided by springs 13,14, causing the blades 1,2 to move in an opposite direction to reduce the size of the opening around the stem, so that the opening is closed on the stem 21 as shown in FIG. 2 and the flowers or leaves 37 are cut off a section 37a of the stem 21, as shown in FIG. 3, by the edges of respective holes 19,20 as the stem 21 is pushed into the opening by an operator (not shown). The edges of one or both of the respective holes 19,20 may optionally be countersunk to produce a sharper cutting edge. Irrespective of whether a sharper edge is provided, the cutting blades use a chisel effect to strip the flowers 22 from the stalk 21.

FIGS. 4-7 illustrate a housing for the blade assembly including the overlapping cutting blades 1,2 shown in FIGS. 1-3. The stalk 21 with flowers is inserted into a stationary funnel 46 mounted on a stationary plate 41, and into the stalk-stripping opening or iris formed by overlapping holes 19,20 in the cutting blades 1,2. After being stripped by the stalk stripping opening or iris, the stripped stalk 21 passes through an opening in rotating mounting plate 52a, which is fixed to and rotatable with the hub 52, and then passes into the hollow interior of hub 52, into which a stalk-pulling dual belt system extends, as illustrated in FIGS. 8, 13, and 14. Bearing posts 15,17 extend from and rotate with the rotating mounting plate 52a. The hub 52 is rotatably mounted to a fixed housing 43 of the cutting assembly by bearings 45. The entire assembly, including the rotating hub 52 is rotated by the drive pulley 44, which includes a Vee cut slot 54 for a drive built 75, illustrated in FIG. 8. The pulley 44 has a pass-through hole 53 for the dual drive stalk-pulling belting, described below.

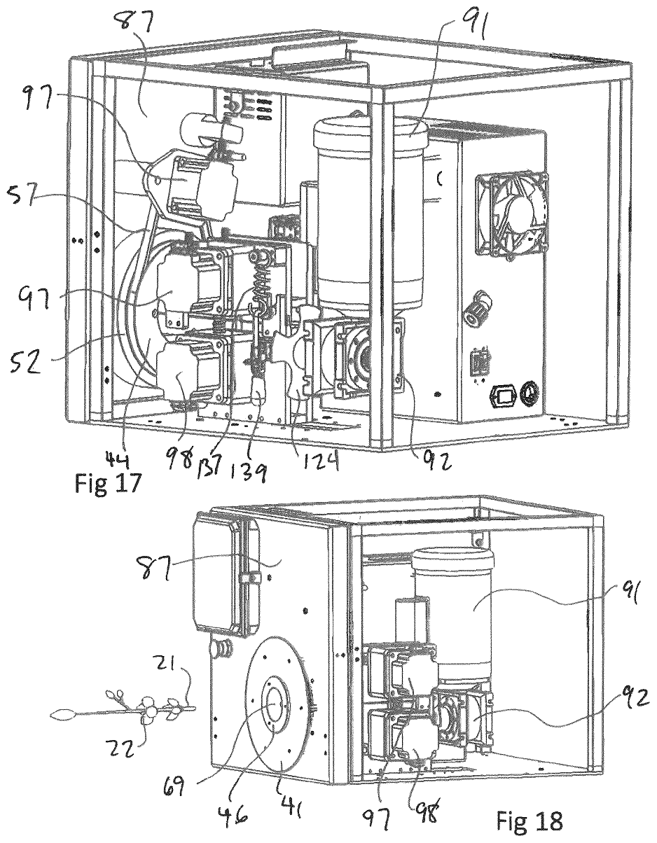

The speed of the rotating cutting blades can be controlled with an electrical input to control predetermined or variable speed controls by adjusting the belt or roller pull speeds relative to the rotating speeds of the cutter to optimized the cut of the flower without snatching the flower from the stem. The electrical input to control cutting blade rotation can be provided by a foot switch, optical sensor or mechanical sensor (not shown) that communicates with the motor controller. The motor 78 that drives the cutter can be a belt driven motor, as shown in FIG. 17, or optionally a hub-less motor with a hollow shaft. The conveyor pull belts are extended through the bearing assembly or hub-less motor to minimize the length of the stem needed to engage with the stem to pull it through the cutters. In addition, the rotation of the cutting plates or blades 1,2 can be controlled by a loadcell on the bearing assembly, or an on/off timer that spins the cutting blades 1,2 at a predetermined amount of time after the presence of a stalk 21 is sensed, before the cutting blades 1,2 open again by stopping rotation or slowing the cutting mechanism rotation speed.

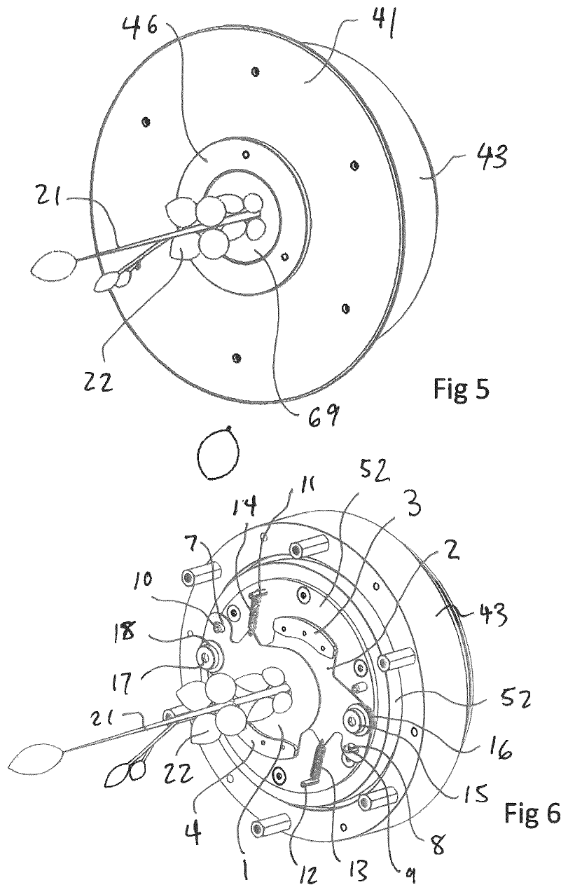

It will be appreciated by those skilled in the art that when the stalk 21 is pulled to a position 65a at which an apex flower 65 is attached to the stalk, as shown in FIGS. 5 and 6, the iris or opening formed by holes 19,20 in cutting blades 1,2 must pinch the stalk in such a way that the flowers will be cut at the apex where the flower stem meets the stalk. In addition, the edges of the iris or opening must be sufficiently sharp to cut through branches 66 at the point 66a wherein the branches 66 meet the stalk without cutting into the stalk itself. Appropriate pinching and cutting forces can be controlled by controlling the rotating speed of the cutting assembly and the speed at which the stalk 21 is pulled through the cutting assembly.

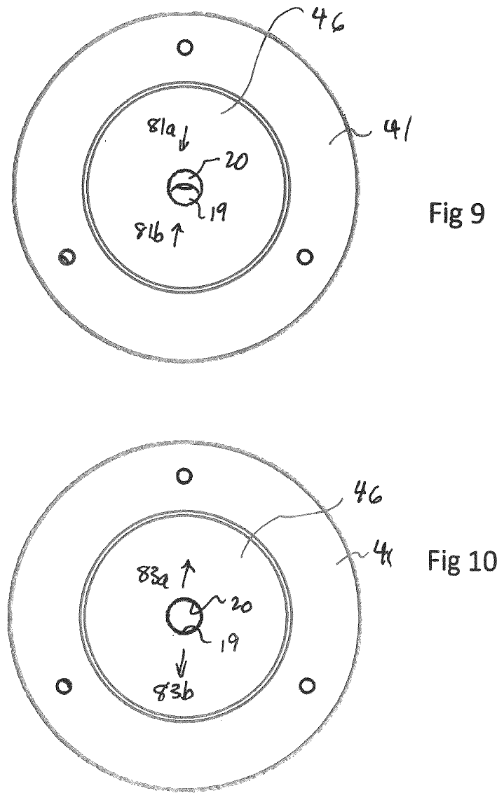

As shown in FIG. 8, a stalk-pulling conveyer belt system extends into the rotating hub 52 to pinch and pull the stalk through the iris opening in the cutting assembly. The stalk-pulling conveyor includes a conveyor drive belt assembly 73 inside of the rotating hub 74. A toggle spring tensioner (described below) applies tension to the conveyor belt assembly 73. FIG. 9 shows the funnel 69 with the top cutting blade 20 closing in the direction of 81a and the bottom cutting blade 19 closing in the direction of 81b to create the closing iris scrape blade. FIG. 10 shows the iris in an open position after the blades 1,2 have been moved in the direction of arrows 83a and 83b by the spring force applied 13,14 after the rotational speed of motor 78 has been reduced to reduce the centrifugal force on the cutting blades 1,2.

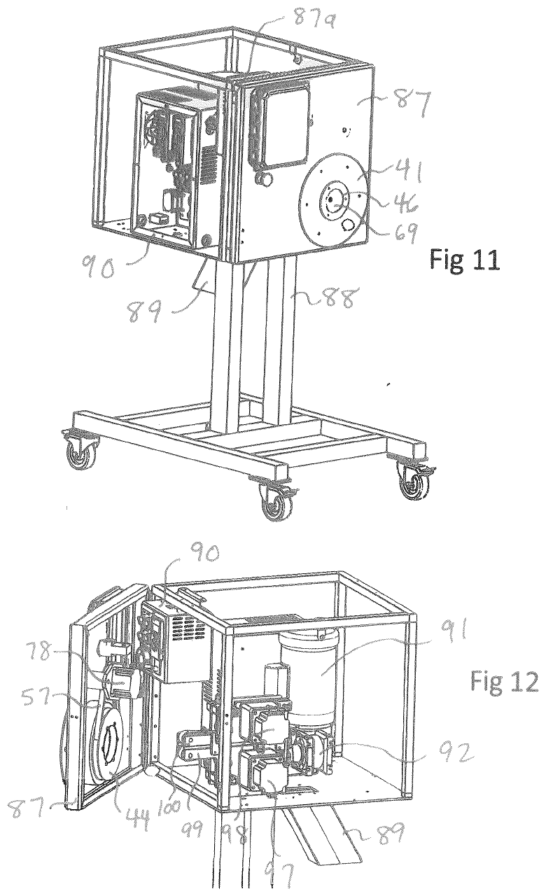

FIGS. 11 and 12 show a complete assembly of the harvester of the exemplary embodiment, which includes the cutting assembly of FIGS. 1-10. The harvester includes a mounting frame 88, discharge chute 89, motor controllers 90d, and a door 87 door with a hinge 78a. The cutting assembly is collectively denoted by reference numeral 86.

In the position shown in FIG. 12, the door 87 is open. The cutter assembly drive motor 78 drives belt 75 to rotate the cutting assembly, as described above. The harvester also includes a discharge stem cutter motor 91 and upper and lower drive belt assemblies 99,100 including stalk pulling drive belts 95,96 and stalk pulling drive belt motors 97,98. Each of the motors is controlled by a controller (not shown) in controller box 90. A biomass waste cutter 92 is provided to cut biomass that has been pulled through the cutting assembly into smaller particles with a rotating blade for discharge through the chute 89 for storage or reduced volume and improved trash removal.

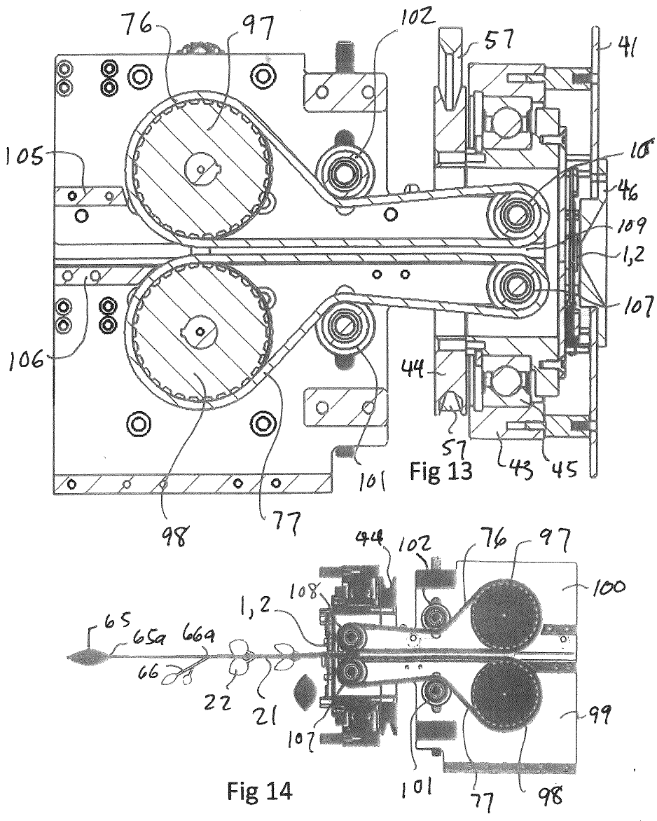

FIG. 13 is a cut-way view of the elongated drive belt assembly 99,100 driven by belt drive motors 97,98 for pulling the stalk through the opening in the cutter assembly. The stalk pulling assembly further includes belt discharge wipers 105,106 for scraping sticky debris from respective belts 76,77, and belt tension adjustors 101,102 for compensating for changes in belt tension due to wear. Also shown in FIG. 13 are a stationary plate 46 which forms the stalk input funnel 69, the belt pinch position 109, and idle pullies 107,108.

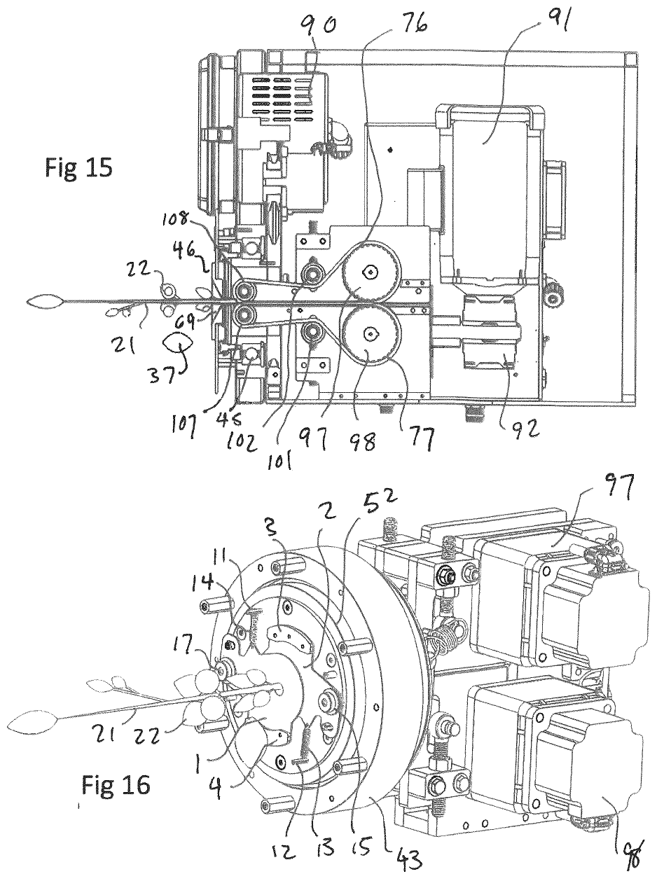

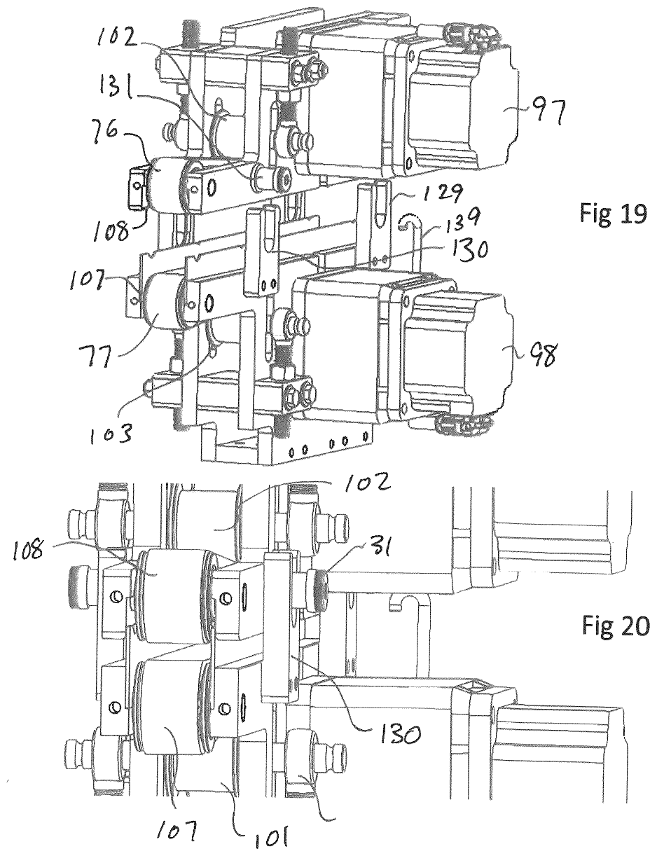

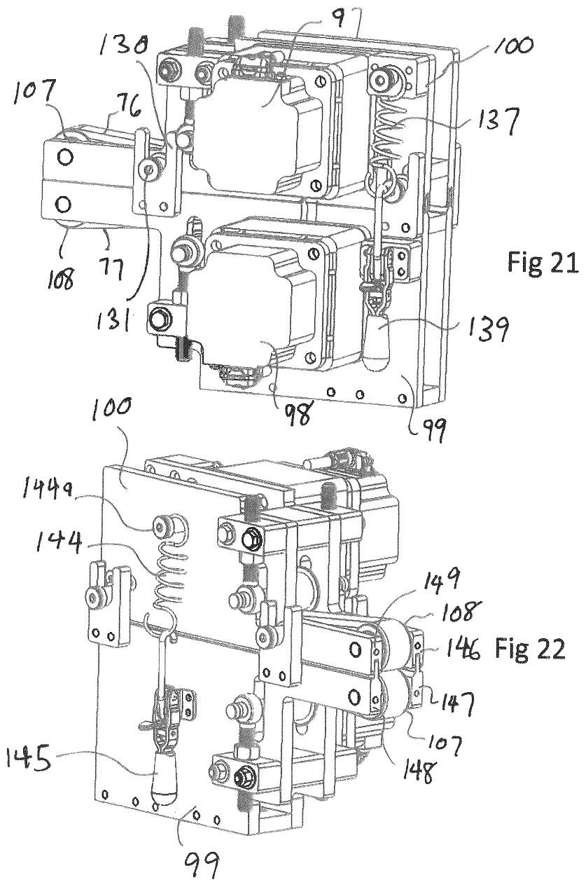

FIGS. 14 and 15 show a stem 21 and cut flower 37, at a point where the stem 21 is being pinched between and pulled by the two independent belt assemblies 99,100 through the cutter opening formed by the overlapping blades 1,2. As shown in FIGS. 19-24, one of the belt pulling assemblies 100 is mounted on bearings 131 that slide in U-slots 130 fixed to the other belt pulling assembly 99, as shown FIGS. 19,20. The bearings 131 are held in U-shots 130 by springs 137 and toggle clamps 139, shown in FIG. 21, so that the belt pulling assembly 100 floats with respect to the belt-pulling assembly 99 and allows the pinch point between the respective belts to change shape in response to varying thickness of the stalk as it is pulled through the opening in the cutter assembly by the stalk pulling belt drive motors 97,98.

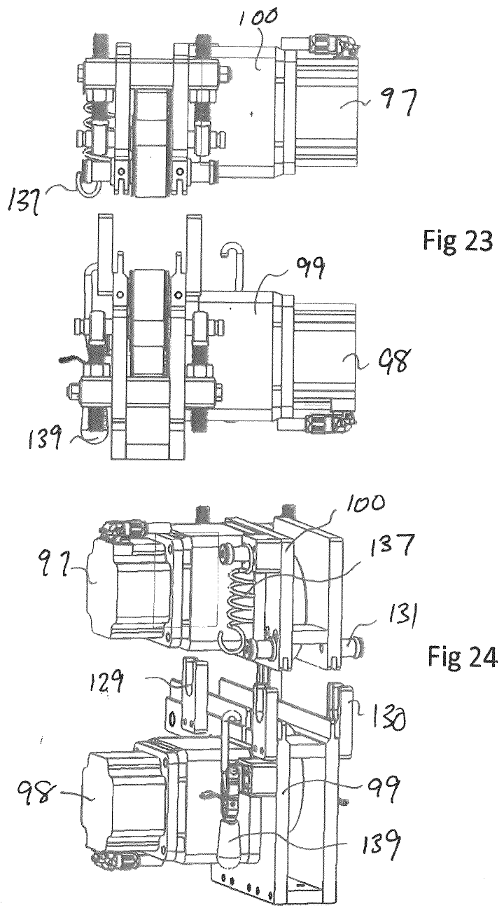

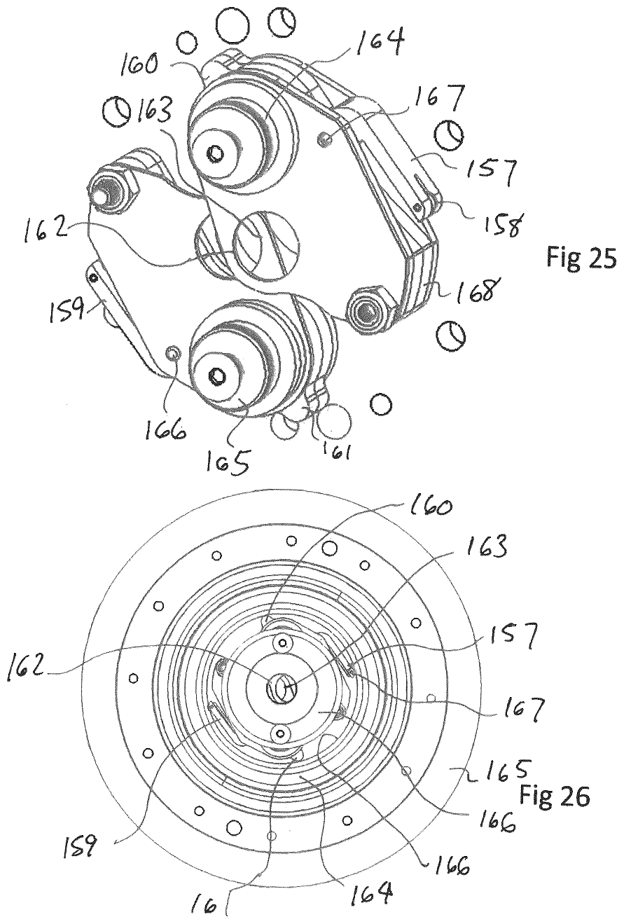

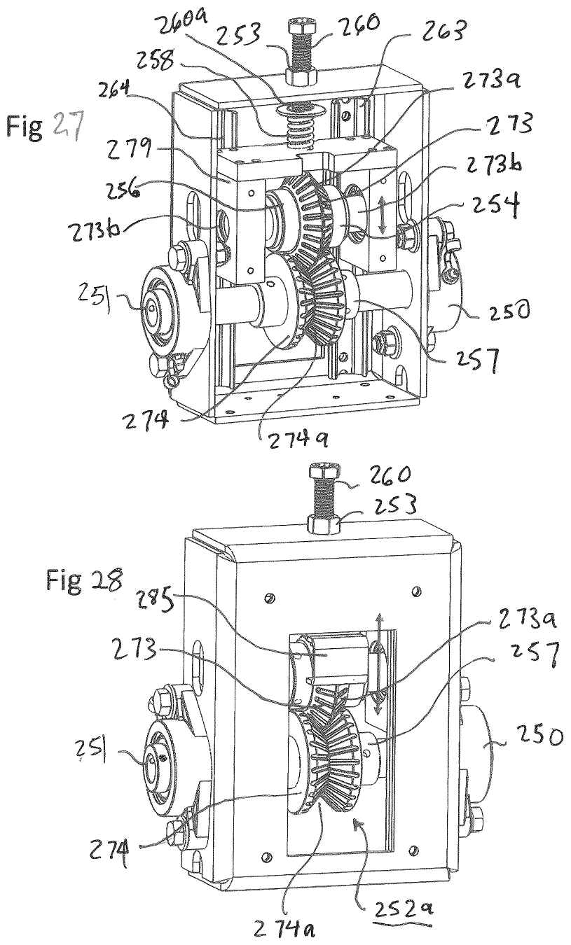

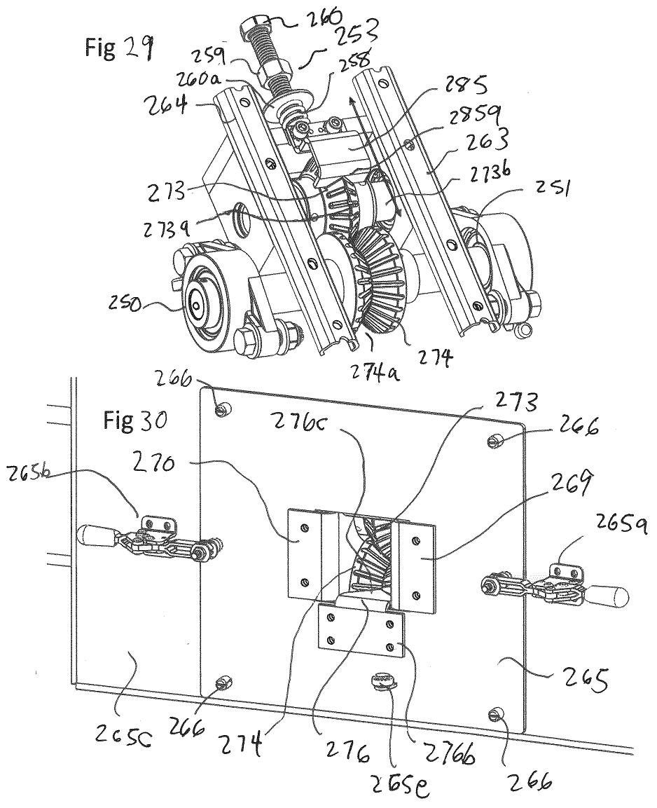

FIG. 18 shows a door 126, frame 127 and cover mount 127a. Toggle clamp 139 hooks onto spring 13, as shown in FIG. 21, to releasably couple one side of the two stalk-pulling belt assemblies 99,100. Release of the toggle clamp 139 allows the springs 137 to be unhooked from the toggle clamp to uncouple the stem pulling belt assemblies and allow bearings 131 to be disengaged from U-shaped slots 129,130 and allow the stalk-pulling belt drive assemblies to be separated for cleaning, as shown in FIGS. 23 and 24. Also shown in FIGS. 21 and 22 are a belt slack adjustment idlers 140,141, which can be used to compensate for stretching of the belts with age, and drive belt assembly 142,143 that extend into the rotating hub 52 to pinch and pull a stalk that has just been stripped.

FIG. 22 shows a toggle clamp 145 for releasably coupling the opposite side of the stalk pulling belt assemblies via a tension spring 144 mounted to a post 144a. Additional male and female wipers 148,149 and 146,147 prevent debris from getting between the two drive assembles. In addition, a top and bottom belt puller with male protrusion 152 and mating female groove 150 is provided, as shown in FIG. 23, to prevent debris from getting between the two top and bottom belt stem pullers during harvesting operation.

FIG. 25 shows a second exemplary embodiment of the invention, in which the harvester includes a predetermined stacked weighted cutter with spring loaded return arms 157,159 with wheels 158 to reduce friction. The stacked weights 168 produce enough centrifugal forces to compress a return spring (not shown) when the cutting housing not shown is spinning.

FIG. 26 is a front view of the harvester of the second exemplary embodiment, including a bearing housing 165 and hub 164, with the two cutting blades 162,164 in FIG. 25. The mechanical stops 160,161 stop against the inner hub 164 that is rotating within the stationary bearing housing 165. The funnel 166 rotates with the blades 1,2.

In both the first and second exemplary embodiments, the precise cutting ability can be adjusted mechanically from the offset of the blade to the edge of the blade follower that is touching the stalk. In each of the exemplary embodiments, the operator of the centrifugal flower cutter may trigger a sensor such as a foot pedal switch or optical switch to send a signal to the motor controller to slow down the blade assembly rotation speed or RPM to a preprogrammed rotation speed or stop. Once the two blade followers have assumed the shape of a hole, the operator or robot arm inserts the stalk into the follower hole. Once the tip of the most significant dimeter end of the branch is inserted, the operator or robot releases the foot pedal or the optical switch changes state to cause the motor controller to increase the rotation speed and capture the stalk between the two or more follower plates or cutting blades, which form the elliptical opening to pinch the stalk. The blade assembly increases the rotation speed that close the pinch follower and align the cutting blade within 0.01 to 0.250 inches from the stalk by the mounting hole spacing between the blade holder and the stalk.

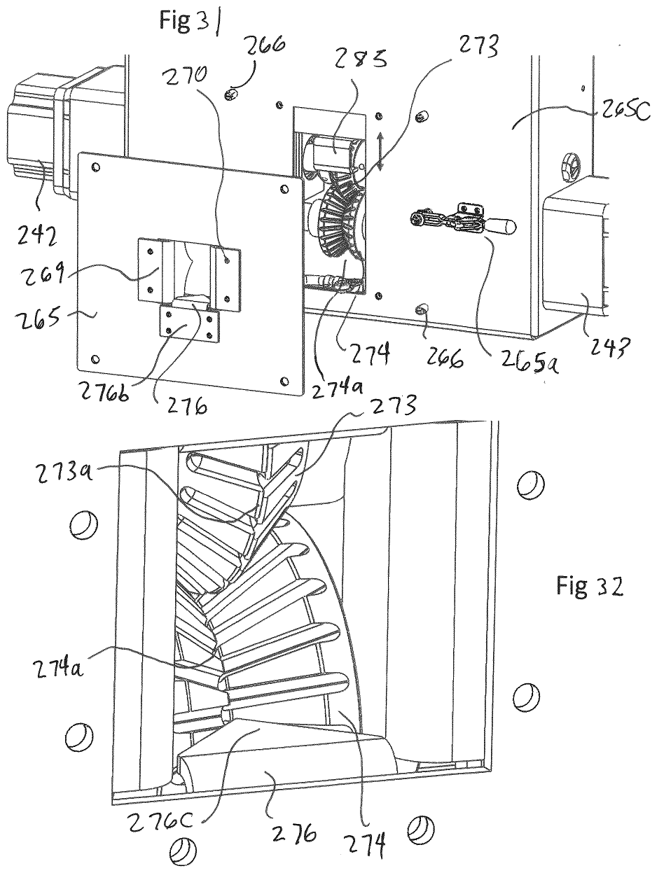

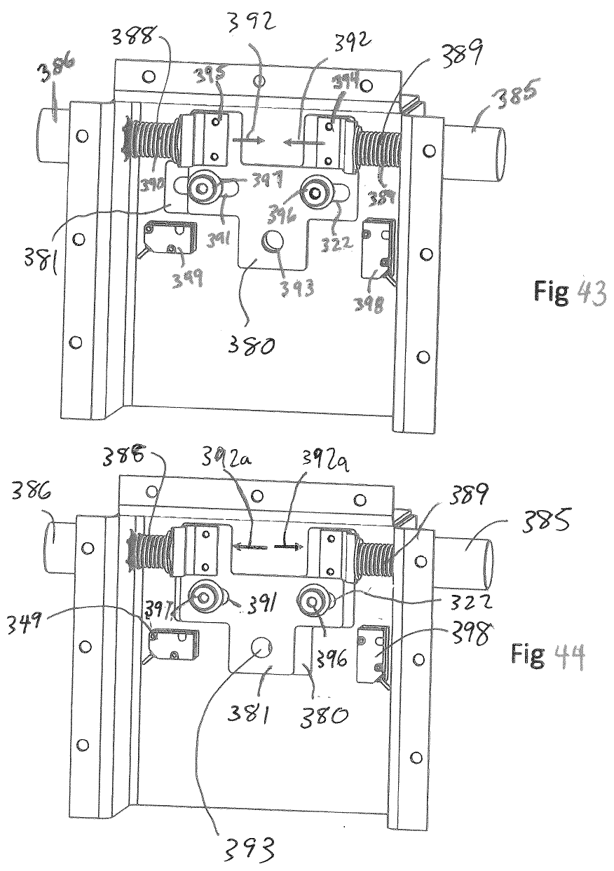

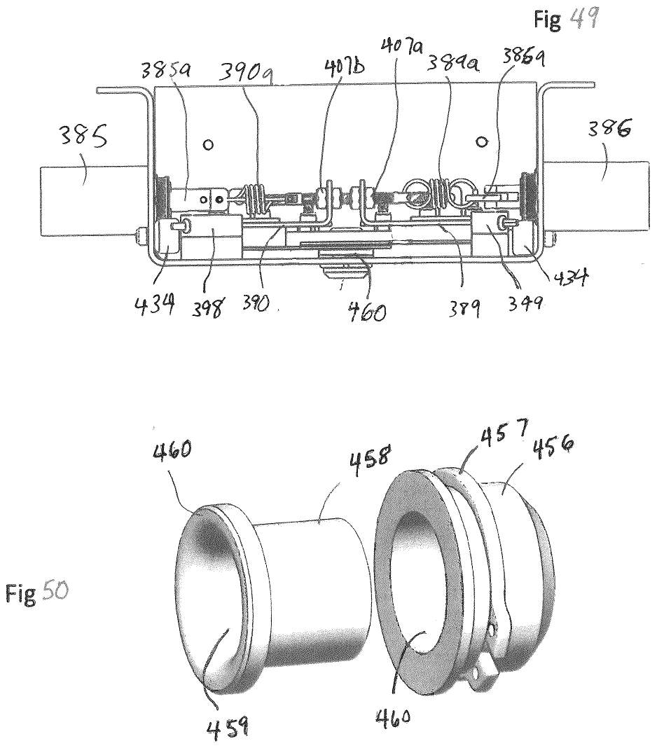

FIGS. 27-53 show variations of the first and second exemplary embodiments, in which the stem pulling belt assemblies of the first and second exemplary embodiments are replaced by drive rollers having “V” and inverted “V” shaped peripheral surfaces as shown in FIGS. 27-42, or by linear sliding pulling mechanisms as shown in FIGS. 48-53, and in which the rotating blade structures are replaced by a linearly movable blade structure with intersecting, iris forming, openings, as shown in FIGS. 43-47,

The pulling mechanism of the third exemplary embodiment of FIGS. 27-42 includes two drive motors 242,243 (shown in FIGS. 31 and 34); a fixed lower drive assembly 252a supported by bearings 250 and 251 and driven to rotate by pulley 257; an upper pinch roller 273 driven to rotate by floating pulleys 254 and 256. The bottom pinch roller 274 of the lower pinch roller assembly 252a has a V-shaped circumferential groove 274a that receives a corresponding V-shaped peripheral surface 273a of the upper pinch roller 273 to frictionally engage the stem, stalk, or branch to advance the stem, stalk, or branch. By using separate motors 242,243 to drive each of the pinch rollers 273,274, the motors require minimal horsepower, thereby saving motor cost, size, and electricity.

The inclusion of rollers with complementary V-shaped and inverted V-shaped circumferential surfaces 273a,274a in the exemplary embodiment of FIGS. 27-42 addresses a heretofore intractable problem with conventional disc-shaped roller drives related to the stickiness and string-like behavior of cannabis, hemp, and other plant-based products when compressed between two radii. The stalk of the plant-based product wants to take the shape of the roller radius, causing a clog as the stalk wraps around the rollers instead of exiting directly out of the back of the harvester. In the third exemplary embodiment of FIGS. 27-42, by not only replacing the dual conveyor belts of the stem pulling mechanism of the first and second exemplary embodiments with pinch rollers, but by utilizing a novel pinch roller design in which the bottom roller 274 has an inverted V-shaped circumferential groove 274a and a floating top roller 273 has a V-shaped peripheral surface 273a that extends into the V-shaped circumferential groove 186a to capture and frictionally engage the stalk. Furthermore, the stalk can be moved in forward and reverse directions as the respective rollers are synchronously rotated in corresponding forward and reverse directions by the pair of motors 243,244, for example via respective drive trains or transmissions that may, by way of example and not limitation, include belts (not shown) and the respective pulleys 256,257.

In order to facilitate removal of sticky debris from the rollers, the third exemplary embodiment of thee invention includes a unique wiper arrangement in which, as shown in FIGS. 28, 29, 31, and 32, a fixed bottom wiper 276 engages the V-shaped groove 186a of the bottom 274 roller to wipe the branch or stem off the roller during rotation, while a top wiper 285 moves with the floating top roller 273 to maintain engagement with and scrape the apex of the V-shaped periphery of the top roller 273, thereby preventing a clog from the branch or stem that could follow the rollers. To enable the top wiper 285 to move with the top roller 273 as it adjusts to changes in stalk diameter as the stalk is pulled passed the flower-removing blade assembly, the top wiper 285 and bearings 273b for the floating top roller 273 are slidably mounted on a pair of linear tracks 263,264 to enable the top wiper to follow the travel of the top roller 273 as it moves linearly to accommodate different stem thicknesses, so that the wiping is consistent with the travel of the moving roller as it slides on linear tracks 263,264. The bottom wiper 276 is fixed with respect to the bottom pinch roller assembly 274, and in particular to an access door 265 secured to the housing 265c of the drive roller assembly by latches 265a and 265b so that the fixed wiper 276 can be removed for cleaning and inspection from both sides of the harvester. Fixed wiper 276 may be removably secured to the door 265 by a knob an optional knob 276a, shown in FIGS. 37-40 to facilitate removal and cleaning or replacement of the fixed wiper.

To prevent and/or clear jams, the motors 242,243 may be reversibly driven by a controller or PLC (not shown) situated in an upper section of housing 265c and responsive to input from a plurality of sensors, as follows:. As shown in FIGS. 35 and 36, the harvester of the third exemplary embodiment has one or more first sensors 288,289 configured to sense whether flowers, stalks or other objects are stuck in the cutters. The drive motors 242,243 may be, for example, BLDC, stepper, inductive, or servo motors, and are controlled by the controller to reverse direction and clear a clog by reversing direction to knock the bunched flowers out of the cutter hole. One or more second sensors 296,299 may be located at the exit of the harvester to detect if a stalk has reached the exit of the device. Once an object is detected at the exit, the signal triggers an adjustable timer that communicates with the motor controller or PLC to reverse the motor for a short period, clearing the clog at the outermost plate of the cutter and continuing forward travel. It will be appreciated that any suitable type of sensor may be used, including laser, capacitive, or photo sensors, or video cameras,

This reversal process automatically removes or prevents clogs through self-cleaning. Instead of relying solely on sensors, the controller may be configured to automatically cause the pinch rollers to periodically reverse direction, while enabling the operator to adjust the timing externally to match the variable stick products being harvested. In either case, the forward rotation time may be set longer than the reverse time to prevent a reversing stem from traveling too far in the reverse direction and disengaging from the pinch rollers.

Also optionally, a knife cutter (not shown) may use a camera to detect the “cola” or central flower cluster that forms along the upper portion of the main stems and large branches in a mature female cannabis plant. Such colas are composed of tightly woven teardrop-shaped buds that can grow upwards of 24 inches when raised in a greenhouse setting. They are a prized possession among growers and consumers due to their high concentration of active resin, as well as their photogenic qualities, which are enhanced by their size and luster. The knife cutter can be activated by a solenoid, stepper motor, or other types of motor, such as a linear actuator, to cut the stems of the colas when they reach the cutters.

The respective drive assemblies for the upper and lower pinch rollers 273,274 may include a pinch adjusting bolt assembly 253 that adjusts the initial position of the floating upper pinch roller 273 to thereby adjust the pressure applied by the upper pinch roller 273 against a stalk that has been squeezed between, and transported by, the floating upper pinch roller 273 and fixed lower pinch roller 274 while wiper 285 travels with the top gear pulley so as to maintain wiping engagement with the upper pinch roller 273 while being guided by tracks. More specifically, the upper pinch roller 273 is rotatably supported by guide roller 264a,264b fixed to the floating bracket 279, which allows the upper pinch roller 273 to move up and down in response to changes in diameter of a stalk as it is pulled through the harvester. The guide rollers 263a,264b, which extend from bracket 279, as shown in FIG. 37, engage and cooperate with rails 263,264 to allow the bracket 279 to move along the rails 263,264 in the direction of arrow 279b. As shown in FIG. 29, the adjusting bolt assembly 253 is attached to floating bracket 279 adjusts the position of upper pinch roller 73 in the direction of arrow 261 by causing it to move along track 240, which includes rails 263 and 264. The adjusting bolt assembly 253 includes a pinch-adjusting spring 258, a fixedly welded bolt 259, and an adjusting screw with a retainer ring and groove (not shown) for compressing washer 260a and therefore spring 258 to adjust the pinch pressure between the upper pinch roller 273 and lower pinch roller 274.

FIGS. 30 and 31 are rear views of the flower harvester of the third exemplary embodiment. As shown therein, the removable wiper access door or plate 265 is secured to the harvester by alignment pins 266 and held in place by the two toggle clamps 265a,265b. Side guide plates 269,270 direct stems and branches out of the pulling zone on either side of the pinch rollers 273,274. The bottom fixed wiper includes a mounting plate 276b and a transversely extending wipe plate 276c, which engages the lower pinch roller 274 to remove sticky plant debris. The bottom wiper 275 is in the shape of a “V” to match the profile of the V-shaped circumferential groove 274a in fixed bottom gear 274. An optional safety limit switch 265e, shown in FIG. 30, may be provided to cut off power to pinch rollers 273,273 if the removable wiper access door or plate 265 is removed during operation.

As is apparent from FIG. 29, which is a close-up perspective view of the rear exit of the pinch roller assembly, the upper wiper 258 includes an extension 258a that enables it to extend into transversely extending slots 258b in the circumference of pinch roller 273 to ensure removal of debris from the slots and circumferential surface of pinch roller 273. Upper wiper 285 is fixed to floating bracket 279 by holders 285c,285d, which are guided by tracks 263,264. As shown in FIG. 37, the extension 285a may include a notch 285e to match the outer peripheral profile 273a of pinch roller 273, although it will be appreciated that the shape of the upper floating wiper 285, as well as lower fixed wiper 276, may be varied without departing from the scope of the invention.

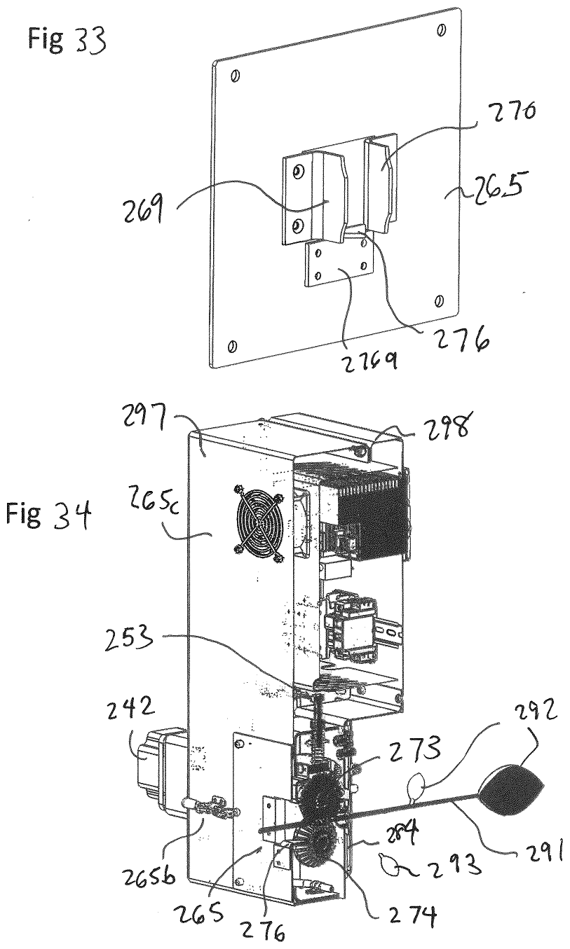

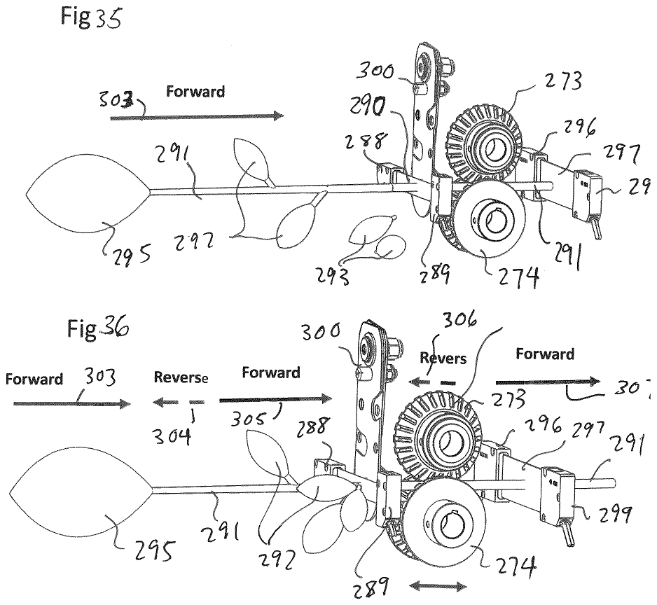

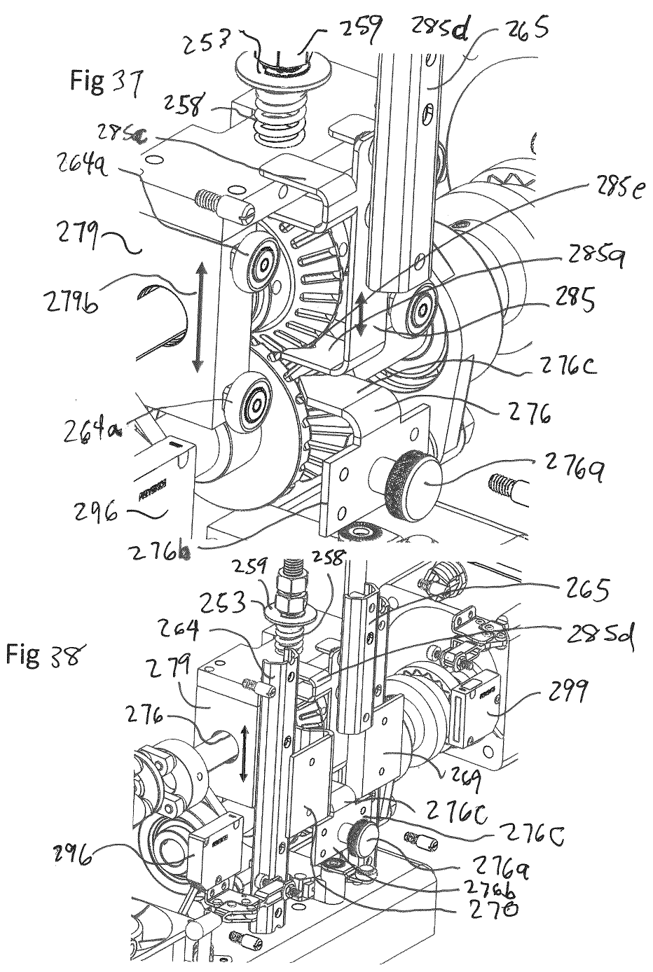

FIG. 33 shows a rear panel 288 including a door 290 with hinged door sections 289 to allow inspection and cleaning of the pulling wheels from both sides when the front door is open. An upper section 297 of the harvester includes a compartment for housing control electronics, accessed through a door 298, as well as gear drive and motor assembly, accessed through the rear panel or door 265 and the front panel 284.

FIGS. 35 and 36 are perspective cut-away views illustrating the operation of the harvester of the third exemplary embodiment, showing uncut flowers 292 on a stalk 291 and a flower 293 that has been cut as the stem is pulled through the cutting assembly 300 by the upper pinch roller 273 and the lower pinch roller 274. Cutting assembly 300 may correspond to the one shown in FIGS. 1-10 or the one described below in connection with FIGS. 43-50.

As shown in FIGS. 35 and 36, sensors 288,289, which may for example consist of a laser or photodiode transmitter and receiver, detect whether the stalk 291 has interrupted beam 290 and is therefore present to activate the mechanisms that close the blades to pinch and cut the flower 292,293 and a cola 295 from the stem 291 as the stem is pulled in a forward direction by upper and lower pinch rollers 273,274. Until the beams 297 of the exit detector 314,316 are interrupted by passing of the stem 291, the upper and lower pinch rollers 273,274 will continue to rotate in a direction that pulls the stalk 291 past the cutter assembly 300 in the forward direction. However, as shown in FIG. 36, when the stem crosses the exit detector beam 297, a reset on/off timer or PLC (not shown) is triggered to start a forward and reverse sequence in the directions of arrows 303-307 to prevent the flower from bunching, so that the sticky flowers will fall under gravity, with the reversing stalk acting like a plunger to release the cut flower 293 from the cutting opening before the uncut flower 292 arrives. The exit sensor controls a timer reset on/off relay that sends a signal to one or more motor controller to cause the roller driving motors 241,242 to change rotation direction after a slight delay. If present, a cola 295 can be identified using a video camera so that it can be cut by a separate knife cutter (not shown) before reaching the harvester.

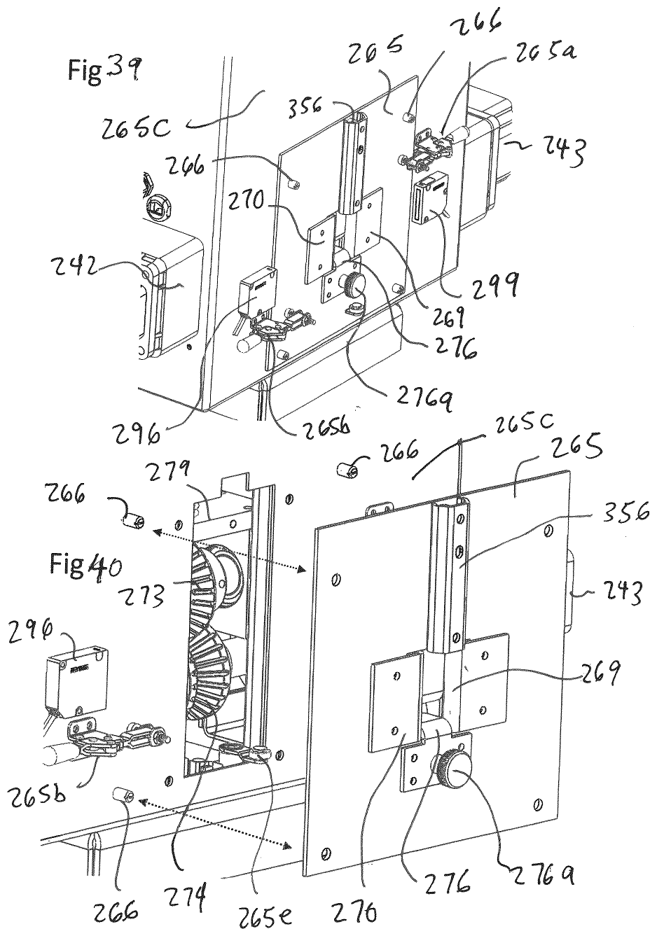

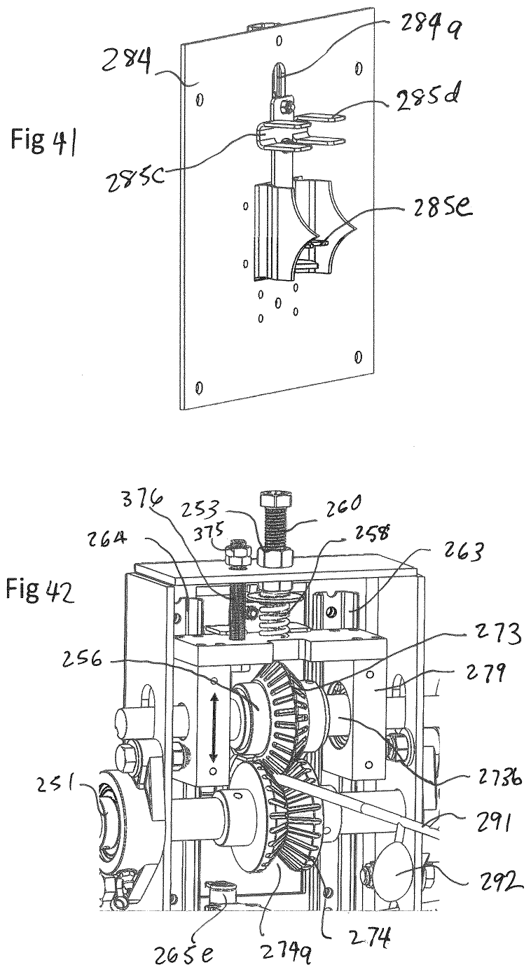

FIGS. 37 and 38 show details, without the side funneling plates and covers, of a variation of the third exemplary embodiment in which the position of linear slide wiper 285 may be adjusted by enabling it to move up and down with a spring adjustment bracket 253, while FIGS. 39 and 40 show details of the cover 256. U-shaped holders or brackets 285c,285d are slidable on a linear track 356 fixed to the cover 256 as shown in FIG. 41, and engage an upper crossbar of the spring adjustment bracket 279 to cause the upper wiper 285 to move up and down in a linear bearing and channel of the linear track 356, in response to movement of a wiper follower for the upper pinch roller 273 upon turning of an adjustment screw or bolt, while the bottom wiper 274 remains fixed. Because the wiper assemblies are secured to the panel 265, as shown in FIG. 41, removal of the door causes the holders or brackets 285c,285d to disengage from the bracket 279, allowing the wipers 276 and 285 to be removed with the door or panel 265 so that they do not get in the way of clearing the pinch rollers. In addition, laser sensors including a transmitter and receiver, which may be identical to transmitter 296 and 299 shown in FIG. 35, are mounted so that the beam between the transmitter and receiver crosses the path of the stem through the pinch rollers and side plates 343,344.

As shown in detail in FIG. 42, the gear drive system may be provided with a threaded adjustable stop bolt 376 and jam nuts 375. The threaded bolt 376 is threaded onto spring-adjustable bracket 279, so that the adjustable end stop bolt 376 prevents the two upper and lower pinch rollers 273 and 274 from exerting too much pressure and possibly jamming.

FIGS. 43 and 44 show an alternative stalk-stripping blade assembly for inclusion in any of the exemplary embodiments. The pincher blades 380,381 include bearings 382,383 that slide in the direction of arrows 392a within slots 390,391 of slotted blade holders 394,395 in response to activation of solenoids 385,386. Upon deactivation of the solenoids, as shown in FIG. 44, compression springs 388,389 return the slotted blade holders 394,395 in the direction of arrows 392 to an open position, awaiting a signal from sensors 349,398 to energize the solenoids in response to detection of a stalk. Instead of solenoids, opening and closing of the blades can be achieved by replacing the solenoids with stepper motors, servo motors, or other linear actuators.

As in the exemplary embodiments of FIGS. 1-26, the flower stripping-opening through which the stem, branch, or stalk is pulled is formed by circular holes 304 in the two pincher blades 380,381. The blades 380,381 are moved by solenoids 385 and 386 to an initial fully open position in which circular holes 304 are aligned to receive a stem, branch, or stalk. Upon de-energization of the solenoids 385,386, the blades are moved by in diametrically opposite directions, reducing the size of the opening formed by the intersecting circular holes 304 and causing respective edges of the circular holes to engage the stalk to strip any flower therefrom.

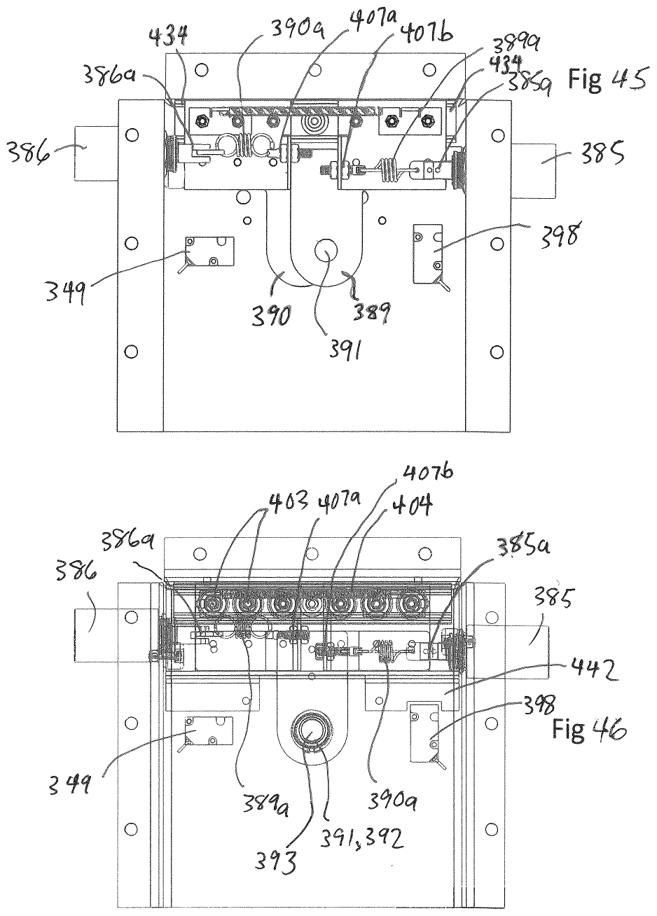

In the variation of the linearly-actuated cutter assembly of FIGS. 43 and 44, shown in FIGS. 45-49, springs 389a and 390a are used to enable movement of modified blades 389,390 and expansion or contraction of the aperture 393 as the diameter of the stalk varies along its length to maintain contact between blades 389,390 and the stalk to enable continuous stripping. First ends of springs 389a,390a are connected the respective pistons 385a,386a extending from solenoids 385,386, while second ends of the springs 389a,390a are coupled to tension screws 407a,407b to enable adjustment of the net spring force provided by springs 389a,386. This action is analogous to that of the first and second exemplary embodiments, except that the blades move linearly rather than pivoting, eliminating the need for a centrifugal second force to maintain contact between the edges of the opening and the stalk. As in the first and second exemplary embodiment, overlapping holes 391,392 in cutting blade members 389,390 form an elliptical opening 393 that changes in eccentricity as the blades are moved in opposite directions. The presence of the stalk in the elliptical opening 393 formed by holes 391,392 may be monitored by sensors 349,398, which output signals to activate or deactivate a stalk pulling mechanism such as the one illustrated in 27-42, and trigger reversal of the stalk pulling mechanism if a jam is detected. In addition to the tension screws 4071,497b, piston 385a includes multiple openings 390b for securing spring 390a to further adjust the spring tension. Again, the solenoids may be replaced by stepper motors, servo motors, or other linear actuators.

According to the variation of the pincher blade assembly shown in FIGS. 45-49, the linear pinch cutter with overlapping blades incorporates ball-bearing wheels 403 inside a curved track 404 that allows the blades 389,390, to operate with a minimum amount of friction for high-duty cycles. Each blade slides independently on the same ball bearing track. When the solenoids 385,386 are not activated, the blades are open and/or closed depending on whether the solenoids are pushed or pulled. In this configuration, they are pulled when activated by a voltage. The spring 409 returns the two sliding blades to the home position as they stop against a rubber cushion 434 and place the blades 381,382 in the open position with no power to the solenoids 385,386. The tension of the pinch is adjustable by the tension screws 407a,407b. For example, the tension can be adjusted to skin the stalk, or to cut the stalk, depending on the application. Sensors 349,398 detect the presence of the branch or stalk. A momentary push button on the machine, not shown, can rapidly open and close the blades to dislodge any debris that may be stuck to them, and remove the debris so that sensor will deactivate the solenoids if no other stalk or stem is present.

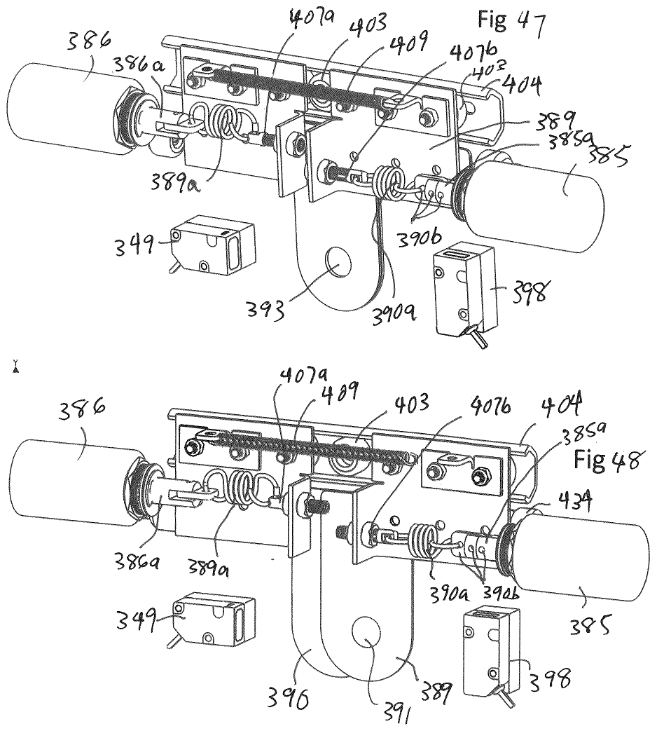

FIG. 46 shows the exemplary arrangement of FIGS. 45-49 with the blades 389,390 in an open position. The rubber stoppers 434 prevent full travel of the linear track. As illustrated, a branch is no longer in the cutters being pinched by the overlapping blades 389,390 but the detectors 349,398 will still see debris. A dust cover 442 may be included to prevent debris from falling into the linear track 439.

FIG. 50 shows an alignment bushing 460 for the cutting blade assembly of FIGS. 43-49. The alignment bushing has a tapered input 459, bushing housing 456, receiver 460, bushing 460 and retainer clip 457. The housing 456 is held in place by retainer clip 457. The bottom blade slides across the bushing 460 when it opens and closes while pinching a stalk as it is being pulled by the pulling mechanism.

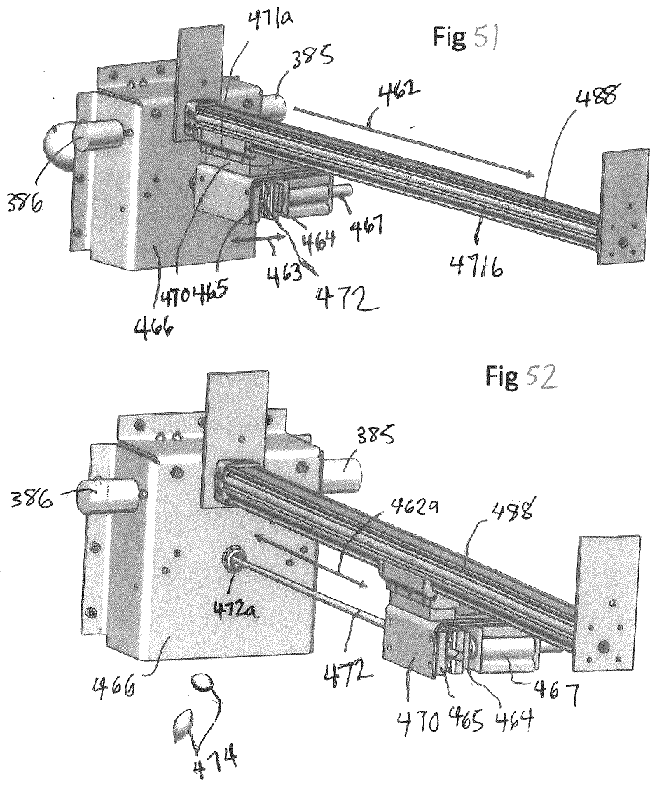

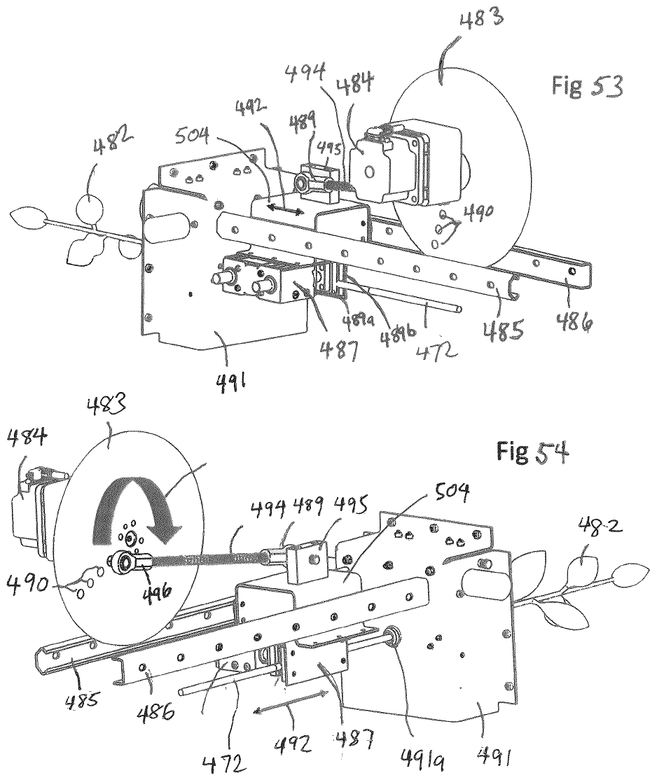

FIGS. 51 and 52 show a third exemplary embodiment of a stalk pulling mechanism, in which the respective belts and rollers of the first and second exemplary embodiments are replaced by a gripping device 470 including jaws 464,465 that grip and hold a leading end of a stalk 467 after it has passed through the cutting mechanism 466, and that pull the stalk along a linear track 471. As shown in FIG. 51, the gripping device 470 is closed on a stalk 472 when a sensor (not shown) senses the presence of the stalk. Jaw 464 is fixed while jaw 465 is moved by, for example, a solenoid 477. After gripping the stalk 472, the gripping mechanism is moved along the track 488 in the direction of arrow 462 by a linear actuator having for example, a stator 471a and cooperating armature 472b, or by any other suitable mechanism for moving the gripping device 470, such as a linear rodless air cylinder, servo, stepper motor, or brushless linear DC motor. When a limit switch (not shown) indicates that the gripping device has reached the end of its travel, as shown in FIG. 52, the solenoid is deenergized to open the jaws 464,465 and release the stalk 472, and the gripping device 470 returns to the home position adjacent the exit opening 472a of the cutting blade assembly 466. If the stalk 472 is detected upon return to the home position, the jaws 464,465 of the gripping device re-close and the gripping device again advances along the track 488 to further pull the stalk 472 through the cutting mechanism 466. If the stalk 472 is no longer detected, the gripping device remains open at the home position and awaits detection of another stalk.

A third sensor (not shown) may optionally also be provided to cause reversal of the direction of travel of the gripping device for a brief interval, such as a second, to along the linear track in order to drive the stem in a reverse direction for an inch or more to free any clogs of debris 474 from the cutter blade assembly. The jaws 464,465 remain closed during reversal, followed by resumption of pulling in a forward direction as indicated by arrow 462a to cut new flowers entering the cutting zone.

FIGS. 53 and 54 illustrate yet another exemplary linear pulling mechanism, in which the stalk gripping mechanism 487 is reciprocally moved along tracks 485,486 by a rotary crank device that includes motor 484, crank wheel 483, and crank arm 494. Crank wheel 483 is rotated by motor 484 in the direction indicated by arrow 484a. One end of crank arm 494 is fixed to a telescoping pivot joint 489 slidably coupled to an extension 504 of the gripping mechanism 487 by a pivotal connector 495. The second end of the crank arm 494 is coupled to the crank wheel 483 by a crank arm connector 496 pivotally secured to one of a plurality of radially aligned openings 490 in the crank wheel 483 to allow adjustment of the range of linear motion of the gripping mechanism by selecting which of the openings to connect the crank arm connector 496. As in the embodiment of FIGS. 51 and 52, the jaws 489a,489b of the gripping device 489 are opened at a home position adjacent an exit opening 491a of the cutting mechanism 491 to receive a stalk 472, and then closed to grip the stalk 472 as the gripping mechanism is moved linearly in the direction of arrow 492 away from the opening 491a. The jaws 489a,489b of gripping device 489 are then opened at the limit of travel of the gripping mechanism 487, which in this example is determined by the radius of the crank wheel 483 and the position of the crank arm 494 on the crank wheel, i.e., the position of the opening 490 to which the crank arm connector 489 is secured. The motor 484 may be reversed for brief periods during travel, without opening the jaws of the gripping mechanism 487, to reverse the pulling direction in order to prevent clogging of the cutting mechanism.

Although a number of embodiments of the invention have been described in detail in connection with the accompanying drawings, it will be appreciated that modifications of the illustrated embodiments may be made without departing from the scope of the invention. For example, the rotating stalk-stripping iris assembly of the first exemplary embodiment may include an iris follower that includes a fixed plate with a hole and countersink rotating plate rather that the illustrated pivotal top and bottom plates with cutting blades 1,2, each having a circular hole and a bearing surface against which a force is applied to pivot the plates. In addition, the use of centrifugal force may be replaced by a system that using electromagnetic forces to pivot the cutting blades and change the size of the stalk-stripping opening. If the cutting assembly is electromagnetically actuated, the cutter assembly follower's electromagnetic coils can be placed around the spinning non-magnetic housing to activate a steel holder using magnetic forces at the while the cutter assemble is spinning to open or close the follower while the cutter assemblies are spinning. Still further, the belt drive for rotating the cutting assembly may be replaced by a hub-less motor with a hollow shaft.

In addition, in the linearly-movable cutting blade and linear stalk-pulling embodiments, a digital switch or HMI control panel may be included to program blade spring tension and/or length of pull for a servo or stepper motor actuated linear stem pull.

These and other variations or modifications are intended to be included within the scope of the invention and, as a result, the invention is not to be limited by the above description or the accompanying drawings, but rather is to be defined solely in accordance with the appended claims.

What is claimed is:

1. Apparatus for stripping cannabis flower from a stem, branch, or stalk of a cannabis plant, comprising:
a cutting assembly including at least two movable plates that cooperate to form an opening through which the stem, branch, or stalk is pulled, wherein edges of the opening engage the stem, branch, or stalk to strip the cannabis flower from the stem, branch or stalk as it is pulled through the opening, wherein movement of the two movable plates in respective mutually opposed first directions increases a size of the opening, and wherein movement of the two movable plates in respective second directions opposite the first directions decreases the size of the opening until edges of the opening engage the stem, branch or stalk as it is pulled through the opening;
a stalk pulling assembly that includes a stalk-gripping mechanism configured to pinch the stalk, stem, or branch and pull it past the cutting assembly, said stalk-gripping mechanism including at least one of a pair drive belts, a pair of pinch rollers having complementary V-shaped circumferential surfaces, and a gripping mechanism including a pair of jaws that is movable along a linear track and reciprocally driven by a linear actuator or crank mechanism.

2. Apparatus as claimed in claim 1, wherein the stalk pulling assembly comprises the pair of pinch rollers, a first of which includes an inverted V-shaped circumferential groove, and a second of which includes a V-shaped outer circumferential surface whose apex extends into the inverted V-shaped groove to grip a stalk between the drive rollers, one of the first and second pinch rollers being movably mounted and spring-biased to exert a predetermined gripping force on the stalk in response to changes in stalk diameter as the stalk is pulled though the cutting opening upon rotation of the drive rollers.

3. Apparatus as claimed in claim 2, wherein a rotation axis of the first pinch roller is fixed and a rotation axis of the second pinch roller is movable, the second pinch roller including a shaft that is coupled to bearings positioned in a linearly movable bracket, the movable bracket being slidable along a track that extends transversely to the rotation axes of the first and second drive rollers.

4. Apparatus as claimed in claim 3, wherein the predetermined gripping force is adjustable by adjusting an initial position of the movable bracket with respect to the track.

5. Apparatus as claimed in claim 3, further comprising a fixed wiper positioned to engage and remove debris from a surface of the V-shaped groove in the first pinch roller, and a movable wiper positioned to move with an engage a surface of the V-shaped circumference of the second pinch roller, said movable wiper being fixed to the movable bracket.

6. Apparatus as claimed in claim 5, wherein the surfaces of the V-shaped groove and the V-shaped circumference include slots that extend generally in a direction of the rotation axes of the first and second pinch rollers.

7. Apparatus as claimed in claim 2, wherein the first and second drive rollers are each driven to rotate by a separate drive motor.

8. Apparatus as claimed in claim 7, wherein the separate drive motors are coupled to the respective first and second pinch rollers by respective belts and pulleys.

9. Apparatus as claimed in claim 7, wherein each separate drive motor is reversible to reverse movement of the stalk in order to prevent or clear jams.

10. Apparatus as claimed in claim 1, wherein stalk-pulling assembly includes a gripping device having a pair of jaws, the gripping device being movable along a linear track and reciprocally driven by a linear actuator or crank mechanism, wherein the jaws are configured clamp the stalk at an initial position near an exit opening of the cutting blade mechanism and to pull the stalk through the cutting blade mechanism when the gripping device is moved along the linear track in a direction away from the exit opening, and wherein the jaws are configured to release the stalk at a distal end of the track in order to release the stalk and enable the gripping device to return to the initial position in order to grip the stalk again so as to continue pulling of the stalk through the cutting assembly.

11. Apparatus as claimed in claim 10, wherein the jaws are actuated by an air cylinder or solenoid.

12. Apparatus as claimed in claim 10, wherein the gripping device is movable along the track by an air cylinder.

13. Apparatus as claimed in claim 10, wherein the gripping device is configured to reverse direction periodically for brief intervals during pulling of the stalk in order to prevent jamming in the cutting assembly.

14. Apparatus as claimed in claim 10, wherein the gripping device is pivotally coupled to a first end of a crank arm, a second end of the crank arm being coupled to a rotating member such that the gripping device is driven to move in forwards and backwards directions along the linear track in response to rotation of the rotating member.

15. Apparatus as claimed in claim 10, further comprising sensors for detecting a presence of a stalk at the initial position of the gripping device, and for detecting a movement or position of the gripping device along the track.

16. Apparatus as claimed in claim 1, wherein the two movable plates of the cutting assembly are slidable along a linear track and caused to be moved is the mutually opposed first directions by solenoids in order to increase the size of the opening and permit insertion of a stalk, and wherein the two movable plates of the cutting assembly are caused to engage the stalk upon deactivation of the solenoids by at least one spring member that pulls the two movable plates in said mutually opposed second directions until sides of the opening engage the stalk, the springs enabling the movable plates to move in response to changes in a diameter of the stalk as it is pulled through the opening and thereby strip the stalk of leaves and flowers.

17. Apparatus as claimed in claim 16, wherein the opening through which the stalk, stem, or branch is pulled is formed by the intersection of overlapping circular holes in the two plates to form an elliptical opening that increases in eccentricity as the plates are moved in said second mutually opposed directions.

18. Apparatus as claimed in claim 16, wherein the two movable plates are coupled to the track by roller bearings.

19. Apparatus as claimed in claim 16, further comprising sensors for detecting a presence and/or movement of a stalk withing the cutting assembly, said sensors including a series of sensors that monitor the opening and closing of the blades, a series of sensors that monitor the flower or stem in front of the blades, and a series of sensors that monitor the stem position in the linear actuator gripper pulling station and a home position of the linear actuator to enable the linear actuator and gripper to operate in concert with each other.

20. Apparatus as claimed in claim 16, wherein a pressure applied to a stalk by the movable blades by the at least one spring is adjustable by adjusting a length of the at least one spring by changing a position at which an end of the at least one spring is secured to at least one of the movable plates.
